(19) United States
(12) Patent Application Publication
(10) Pub. No.: US 2007/0000048 A1
(43) Pub. Date: Jan. 4, 2007

(54) PNEUMATIC LIFT AND METHOD FOR TRANSFERRING AN INVALID PATIENT

(76) Inventor: David T. Davis, Bethlehem, PA (US)

Correspondence Address: DUANE MORRIS LLP;IP DEPARTMENT, 30 SOUTH 17TH STREET, PHILADELPHIA, PA, 19103-4196, US

(21) Appl. No.: 11/428,733

(22) Filed: Jul. 5, 2006

Related U.S. Application Data
(63) Continuation-in-part of application No. 11/013,761, filed on Dec. 16, 2004.

(51) Int. Cl. A61G 7/10

(52) U.S. Cl. 5/81.1 R

(57) ABSTRACT

A pneumatic lift including at least three jacking-mattresses stacked one atop another and arranged in air flow communication with one another where a top one of the jacking mattresses defines a foot end with a pouch-flap secured to that foot end so as to form a pocket. At least one of the jacking-mattresses is also arranged in air flow communication with a source of pressurized air.

### PNEUMATIC LIFT AND METHOD FOR TRANSFERRING AN INVALID PATIENT

This application is a continuation in part of copending U.S. patent application Ser. No. 11/013,761, filed Dec. 16, 2004, and entitled Pneumatic Lift.

### FIELD OF THE INVENTION

The present invention generally relates to devices suitable for lifting living creatures and, more particularly, to a pneumatic lift suitable for use in vertically moving living creatures.

### BACKGROUND OF THE INVENTION

There is a need for a compact, lightweight and easily portable patient lifting device to assist caregivers in lifting prone patients from a lower position, e.g., the floor, to a relatively higher position, e.g., a bed, table, gurney, or vehicle, etc.; for use in the home, in institutional settings, and in the outside world. Transferring of disabled patients is a leading cause of injury in the health-care industry, with the nursing occupation having among the highest incidence of back injury, despite the prior art and the availability of commercial patient lifts. These lifts are under-utilized utilized for a number of reasons, such as restricted space in many hospital wards and bathrooms, cumbersome operating requirements, the indignity involved in the mode of transport, the additional time required for performing the transfer, and the unavailability of the lift at both the patient's starting and destination locations. In addition, many patients are essentially home-bound due to the unavailability of a conveniently portable lift, reducing their quality of life unnecessarily. A device is required that is simple to set up and use, feels safe, secure and is not intimidating for the patient, and can be transported with the patient.

This problem is pervasive in the home health care industry as well, where spaces are not designed for safe patient transfers, and the caregiver is often alone and has no help during lifts. Since conventional lifts are available in less than ten percent of the homes visited by home health care professionals, a device that can be easily brought from home to home is also required. In addition, most prior art lifting devices do not provide for the reduction of hip and back deflection during lifting. This is a significant problem, since if a person's hip or back is already injured, such uncontrolled deflections could exacerbate the existing condition, or possibly cause additional injury.

While this field contains considerable prior art, these devices have proven inadequate. For example, U.S. Pat. No. 4,805,248, issued to Lunau is typical of ceiling-mounted patient lifts. While effective, these are limited to use in very well defined areas. U.S. Pat. No. 3,137,011, issued to Fischer is representative of a common type of mobile patient lift. A major disadvantage of this design is that the patients are essentially suspended from a hook. The resultant swaying motion during transfer is disconcerting to most patients. In addition, the patient is transported in a partially reclined position, increasing their sense of helplessness and indignity, particularly if used outside in public.

U.S. Pat. No. 3,914,808, issued to Woods teaches the use of a short flexible sling in a front-loading orientation, with a pivoting column. The base must be relatively wide in order to avoid tipping as the column is rotated, and there is no means for compactly transporting or storing the lift. Additionally, the use of a fixed length sling requires that the patient be sitting precisely on the center of the sling, to avoid tipping the patient as the column is raised. This increases the time and training required to use the lift.

Pneumatically inflatable, and hydraulically expandable lifting bags are also known. For example, DE-U-1,897,870 discloses an extendable or inflatable lifting device having a pressure release valve assembly. U.S. Pat. No. 3,695,582, issued to Clay discloses a lifting jack for motor vehicles which uses fluid pressure for operating power to raise the wheel of a vehicle. The jack relies upon a pair of stacked hollow flexible plastic bags that may be filled with a suitable fluid.

In U.S. Pat. No. 5,606,785, issued to Shelberg et al., an inflatable air mattress positioner is provided for use with a casket, coffin or alternative container. The assembly includes a partially pneumatic pillow with a chamber in which is disposed a plurality of air chambers, each one of which has a corresponding air tube and valve assembly. A cushion coacts with the air bladders to position the head, upper arm, chest and shoulder region of a cadaver so that the cadaver chin is disposed in an acceptable proper height in relation with the chest. The assembly includes an inflatable air mattress having a plurality of air chambers which are independently inflatable to position a cadaver at an appropriate height and angle in the casket. Additional separate independent air bladders are also provided to be disposed under the cadaver to aid in positioning the cadaver and tilt the cadaver along its longitudinal axis for mourner viewing as well as positioning the back, arms, head, neck or any other part of the cadaver that requires adjustment.

In the U.S. Pat. Nos.: 4,688,760, 4,786,032, 4,993,736, 5,651,149, and 5,669,086, all issued to Garmen et al., a variety of lifting apparatus are provided that include a base, a platform disposed above the base, a thrust mechanism positioned between the platform and the base to lift the platform with respect to the base. Garmen et al. often choose a pneumatic thrust mechanism in the form of stacked bellows including a flexible wall composed of substantially inelastic material and having a vertically spaced horizontal stiffener. The bellows include an inlet to allow a gaseous material to inflate each bag for applying lifting forces to the platform. U.S. Pat. No. 6,199,827, issued to Rimington, et al., also discloses an extendable or inflatable lifting device

None of the foregoing patents adequately address the problem of insuring that a lift is available at both a patient's starting and final locations. Patient transfer mattresses are also well known in the art which include at least two flexible material sheets, that together define a plenum chamber, with at least one sheet being completely perforated with small pinholes over its surface area, and which open up directly to the interior of the plenum chamber. Such prior art mattresses are used by arranging the perforated sheet so that it faces an underlying fixed, generally planar support surface, such as a floor or table. When the mattress is charged with pressurized air, the escape of air under pressure through the pinholes acts initially to jack a load placed upon the mattress (i.e., to lift the load in increments) and thereby creates an air bearing of relatively small height between the underlying fixed, generally planar support surface and the perforated flexible sheet.

For example, in U. S. Pat. No. 4,517,690, issued to Wegener, an air pallet is disclosed that is formed from upper and lower thin flexible film sheets sealed at their edges to form a plenum chamber. Wegener's air pallet functions to move a load with minimal friction over an underlying generally planar fixed support surface. The bottom thin flexible material sheet is perforated by small diameter perforations such as pin holes.

In U.S. Pat. No. 4,417,639, issued to Wegener, a pair of relatively rigid planar members are arranged overlying each other, and are coupled about their edges by a flexible film band to form a jacking plenum chamber. The upper planar member functions as the load support, having a gas inlet hole adjacent one edge. Gas under pressure enters an end of the jacking plenum chamber and escapes through the outer end which allows for jacking of the load. Wegener's design is only capable of jacking the load, e.g., a patient lying on the mattress, several inches above the underlying support surface.

### Summary Of The Invention

The present invention provides, in its broadest aspects, a pneumatic lift is provided having at least three jacking-mattresses stacked one atop another where at least two of the jacking-mattresses are arranged in internal air flow communication with one another. A top one of the jacking mattresses defines a foot end with a pouch-flap secured to the foot end so as to form a pocket that is suitable for enclosing and securing a patient's feet and lower legs. In this way, if the pneumatic lift must be used to transport a patient, e.g., down a stairway, the patient will feel as though they are securely held in place atop the lift.

In one embodiment, each of the jacking-mattresses includes a top panel having a width, a length, a peripheral edge, a bottom panel having the same width, length, and a peripheral edge, and a perimeter band extending between the top panel and the bottom panel. The peripheral edges of the top and bottom panels are sealingly fastened to one another to form the jacking-mattress. The peripheral band defines at least one through-hole for air flow communication with the interior of at least one other jacking-mattress. A plurality of baffle-panels are also provided each having a width and a length and being attached to an inner surface of the top panel and an inner surface of the bottom panel so as to be transversely oriented between the top panel and the bottom panel. In this way, the baffle-panels define a pair of longitudinally extending air flow passageways disposed between an edge of the baffle-panels and an interior surface of the perimeter band. At least one conduit is arranged in air flow communication between the at least one through-hole in adjacent jacking-mattresses. A source of pressurized air is arranged in airflow communication with one of the at least one through-holes so as to be in airflow communication with the interior of one of the jacking-mattresses.

In another embodiment of the invention, a pneumatic lift is provided that includes a top jacking-mattress, a bottom jacking-mattress, and a plurality of intermediate jacking-mattresses that are stacked one atop another between the top jacking-mattress and the bottom jacking-mattress. Select ones of the jacking-mattresses are arranged in air flow communication with one another. Each of the jacking-mattresses includes a top panel having a width, a length, a peripheral edge, where select ones of the intermediate jacking-mattresses have a top panel having at least one through-hole. A bottom panel is provided having the width, the length, and a peripheral edge, where corresponding select ones of the intermediate jacking-mattresses have a bottom panel having at least one through-hole. A perimeter band extends between the top panel and the bottom panel of each of the jacking-mattresses such that the peripheral edges of the top and bottom panels are sealingly fastened to one another. A plurality of baffle-panels are provided where each has a width and a length and is attached to an inner surface of the top panel and an inner surface of the bottom panel so as to be transversely oriented between the top panel and the bottom panel. Together, the baffle-panels and the perimeter band define a pair of longitudinally extending air flow passageways disposed between an edge of the baffle-panels and an interior surface of the perimeter band. A source of pressurized air is arranged in airflow communication with the interior of at least one of the jacking-mattresses.

In a further embodiment of the invention, a transportable pneumatic lift is provided including a plurality of jacking-mattresses stacked one atop another with selected ones of the jacking-mattresses being arranged in internal air flow communication with one another. A transfer mattress forms a bottom most jacking-mattress. The transfer mattress includes a top panel having a width, a length, and a peripheral edge and a bottom panel having the same width, the same length, and a peripheral edge. A plurality of pinholes are defined in a central portion of the bottom panel. An outer perimeter band extends between the top panel and the bottom panel such that the peripheral edges of the top and bottom panels are sealingly fastened to one another. A plurality of baffle-panels are attached to an inner surface of the top panel and an inner surface of the bottom panel so as to be transversely oriented between the top panel and the bottom panel. An inner perimeter band extends between the top panel and the bottom panel and enclosing the plurality of baffle-panels so as to define an annular air flow passageway disposed between the outer perimeter band and the inner perimeter band. The inner perimeter band also encloses the baffle-panels thereby forming individual chambers between the baffles. The annular air flow passageway is in flow communication with the individual chambers. A source of continuous pressurized air is arranged in flow communication with the annular air flow passageway.

In yet a further embodiment, a pneumatic lift is provided including a plurality of jacking-mattresses that are stacked one atop another. Each of the jacking-mattresses has a top panel having a width, a length, a peripheral edge and a foot end. A pouch-flap is secured to a portion of the peripheral edge adjacent to the foot end and arranged so as to form a pocket suitable for accepting and retaining a patient's feet and lower legs during transport. A bottom panel is provided that includes a width, a length, and a peripheral edge that are substantially the same as that of the top panel. A perimeter band extends between the top panel and the bottom panel such that the peripheral edges of the top and bottom panels are sealingly fastened to one another. The peripheral band defines at least one through-hole. A plurality of baffle-panels are included within the chamber formed between the top and bottom panels anf the preimeter band. Each baffle has a width and a length and is attached to an inner surface of the top panel and an inner surface of the bottom panel so as to define air flow passageways. At least one valve is sealingly positioned within the at least one through-hole so as to provide air flow access to the air flow passageways. A source of pressurized air is provided that has a conduit suitable to be sequentially received in airflow communication with each of the at least one valves so as to be in sequential airflow communication with the interior of each of the jacking-mattresses.

### BRIEF DESCRIPTION OF THE DRAWINGS

These and other features and advantages of the present invention will be more fully disclosed in, or rendered obvious by, the following detailed description of the preferred embodiment of the invention, which is to be considered together with the accompanying drawings wherein like numbers refer to like parts and further wherein:

FIG. 1 is an end on perspective view of a pneumatic lift formed in accordance with the present invention and including a pouch-flap located at a foot-portion;

FIG. 2 is another end on perspective view of the pneumatic lift shown in FIG. 1;

FIG. 2a is a broken-away, perspective view of a foot-portion of the pneumatic lift shown in FIG. 1, with a portion of the pouch-flap folded back upon itself;

FIG. 2b is a top plan view of the pneumatic lift shown in FIG. 1;

FIG. 2c is a perspective view of the pneumatic lift shown in FIG. 1, with a portion of patient positioned beneath a pouch-flap located at a foot-portion of a jacking-mattress formed in accordance with the present invention;

FIG. 3 is a partially broken-away, perspective view of a jacking-mattress formed in accordance with the present invention;

FIG. 4 is a broken-away perspective view of a corner portion of the jacking-mattress shown in FIG. 3;

FIG. 5 is a broken-away perspective view of a corner portion of an alternative jacking-mattress having scalloped edged baffle-panels;

FIG. 6 is a broken-away, cross-sectional view of the jacking-mattress having scalloped edged baffle-panels shown in FIG. 5;

FIG. 7 is a broken-away perspective view of a corner end portion of the pneumatic lift shown in FIG. 1;

FIG. 8 is an enlarged view of a first embodiment of jacking-mattress interface;

FIG. 9 is a perspective view of a pneumatic lift shown in FIGS. 7 and 8, in a fully inflated state;

FIG. 10 is a perspective view of the pneumatic lift shown in FIGS. 1, 2, and 9, in a partially deflated state;

FIG. 11 is a perspective view of pneumatic lift shown in FIGS. 1, 2, and 9, after a first jacking-mattress has been inflated;

FIG. 11a is a broken-away, perspective view of a foot-portion of an evacuation jacking-mattress arranged in fluid communication with an air cylinder;

FIG. 11b is a perspective view of the evacuation jacking-mattress shown in FIG. 1a;

FIG. 11c is a broken-away, perspective view of a foot-portion of an evacuation jacking-mattress arranged in fluid communication with an air cylinder and illustrating a fully assembled pouch-flap in place at the foot-portion of the mattress including a pleat pocket;

FIG. 12 is a cross-sectional view, as taken along line 12-12 in FIG. 9, showing one possible internal air movement pattern in accordance with the present invention;

FIG. 13 is a cross-sectional view of the pneumatic lift, as taken along line 13-13 in FIG. 12;

FIG. 14 is an end on perspective view of a pneumatic lift formed in accordance with an alternative embodiment of the present invention;

FIG. 15 is a broken-away perspective view of a corner end portion of the pneumatic lift shown in FIG. 14;

FIG. 16 is an enlarged view of a second embodiment of jacking-mattress interface which is heat sealed or ultrasonically welded;

FIG. 17 is a plan view of a top panel for use with intermediate jacking-mattresses used in connection with the alternative embodiment shown in FIG. 14;

FIG. 18 is a plan view of a bottom panel for use with intermediate jacking-mattresses used in connection with the alternative embodiment shown in FIG. 14;

FIG. 19 is a cross-sectional view of the pneumatic lift shown in FIG. 14, as taken along lines 19-19 in FIG. 14;

FIG. 20 is an enlarged view of a corner section of the pneumatic lift shown in FIG. 20;

FIG. 21 is an end on perspective view of a pneumatic lift formed in accordance with yet a further alternative embodiment of the present invention;

FIG. 22 is a cross-sectional view of the pneumatic lift shown in FIG. 21, as taken along lines 22-22 in FIG. 21;

FIG. 23 is an enlarged view of a corner section of the pneumatic lift shown in FIG. 22;

FIG. 24 is a perspective view of one alternative embodiment of jacking-mattress;

FIG. 25 is a cross-sectional view of the jacking-mattress shown in FIG. 24, as taken along lines 25-25 in FIG. 24;

FIG. 26 is a top view of the jacking-mattress shown in FIGS. 24 and 25 illustrating one seam pattern;

FIG. 27 is an end perspective view of a further alternative embodiment of jacking-mattress including longitudinal internal baffles;

FIG. 28 is a cross-sectional view of the jacking-mattress shown in FIG. 27, as taken along lines 28-28 in FIG. 27;

FIG. 29 is a top plan view of the jacking-mattress shown in FIGS. 27 and 28 showing a seam pattern associated with longitudinal internal baffles;

FIG. 30 is a perspective view of a jacking-mattress used in combination with a transfer mattress according to the present invention;

FIG. 31 is a perspective view of the jacking-mattress and transfer mattress shown in FIG. 30, with the transfer mattress slid transversely relative to the jacking-mattress;

FIG. 32 illustrates a jacking-mattress formed in accordance with the present invention including a low friction sheet for dragging across a smooth surface;

FIG. 33 is a perspective view of a jacking-mattress and transfer mattress combination formed in accordance with the present invention;

FIG. 34 is a perspective view of the jacking-mattress and transfer mattress combination shown in FIG. 33, with the transfer mattress deflated;

FIG. 35 is a perspective view, partially broken away and partially in phantom, of a transfer mattress portion of the jacking-mattress shown in FIGS. 33-34;

FIG. 36 is a top plan view of the transfer mattress portion of the jacking-mattress and transfer mattress combination illustrating a central chamber defined by an inner perimeter band; and

FIG. 37 is a cross-sectional view taken along lines 37-37 in FIG. 36, showing internal structure of the transfer mattress portion of a jacking-mattress and transfer mattress combination.

### DETAILED DESCRIPTION OF THE PREFERRED EMBODIMENT

This description of preferred embodiments is intended to be read in connection with the accompanying drawings, which are to be considered part of the entire written description of this invention. The drawing figures are not necessarily to scale and certain features of the invention may be shown exaggerated in scale or in somewhat schematic form in the interest of clarity and conciseness. In the description, relative terms such as “horizontal,” “vertical,” “up,” “down,” “top” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,”“longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship. In the claims, means-plus-function clauses are intended to cover the structures described, suggested, or rendered obvious by the written description or drawings for performing the recited function, including not only structural equivalents but also equivalent structures.

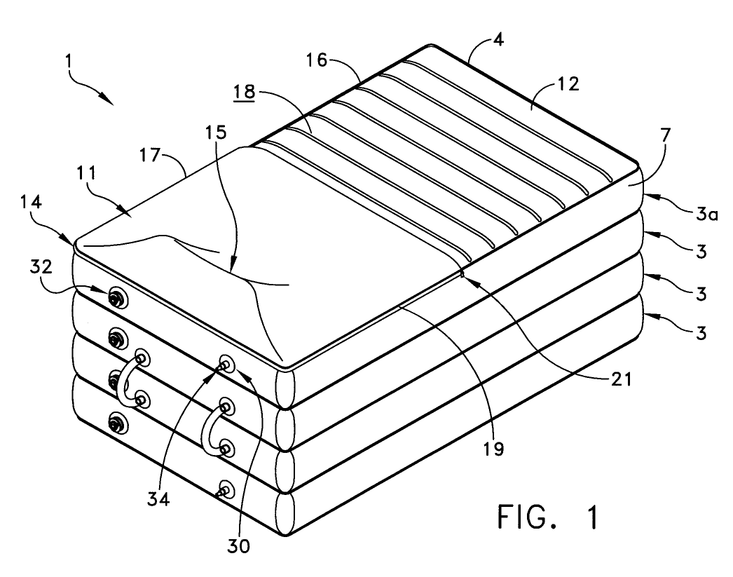

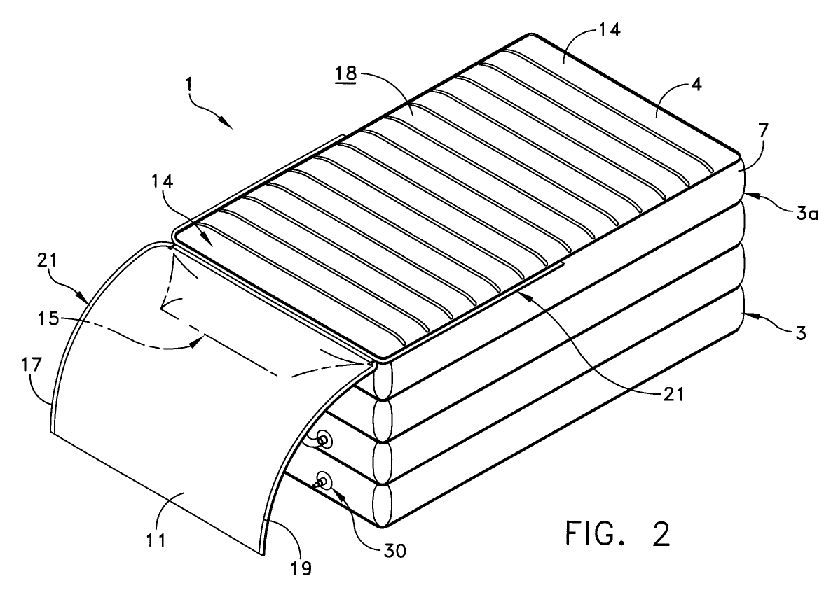

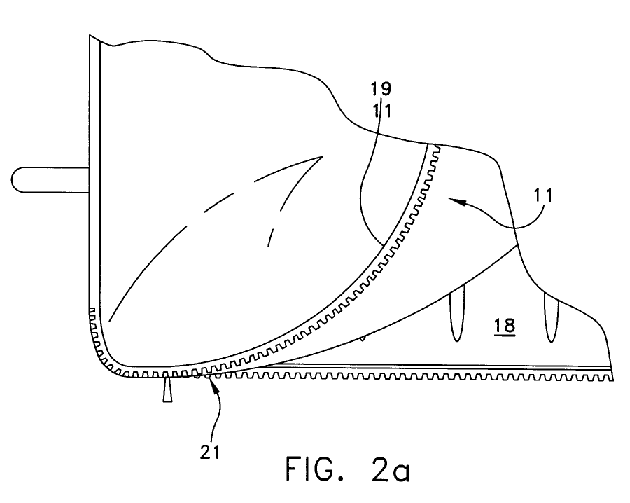

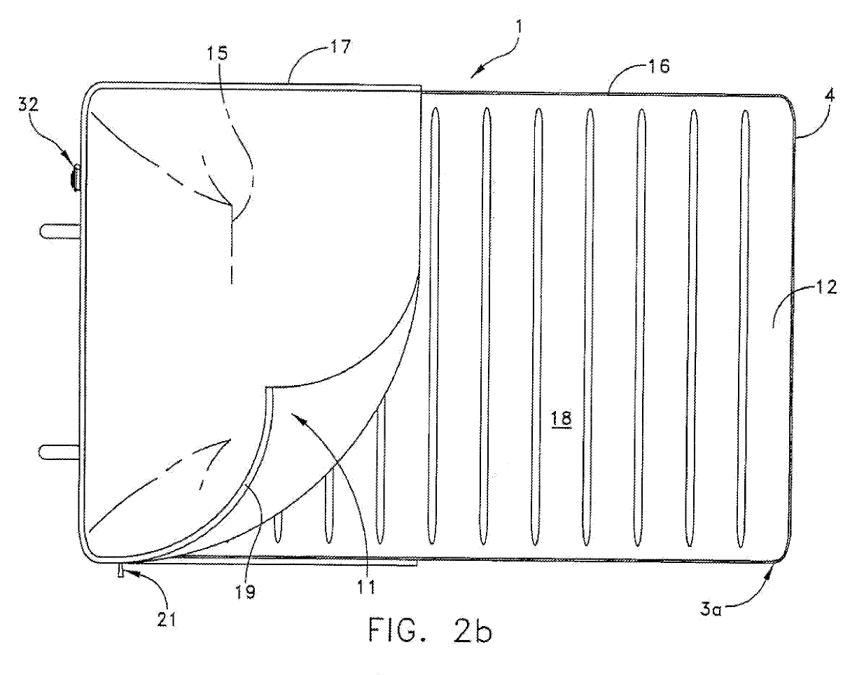

Referring to FIGS. 1-4, a pneumatic lift 1 formed in accordance with one embodiment of the present invention comprises a plurality of jacking-mattresses 3 that are stacked and secured together, one atop another, with a top one of the mattresses 3a having a foot-portion from which is secured a pouch-flap 11. Each individual jacking-mattress 3,3a includes a top panel 4, a bottom panel 6, a perimeter band 7, and a plurality of internally disposed, transverse baffle-panels 8. More particularly, top panel 4 comprises a head portion 12, a foot portion 14, and a peripheral edge 16, and is formed from a sheet of nylon scrim or the like, that is coated on at least its outer surface 18 with a water proof coating. The inner surface of top panel 4 may also be coated with a water proof coating as well. Water proof coatings that may be used in connection with the invention include any of the well known polymeric or elastomeric compounds that are known to be impervious to semi-solids and liquids, such as, blood, urine, feces, hospital strength disinfecting compounds, alcohol, or the like. Pouch-flap 11 may be formed from the same sheet of nylon scrim that forms top panel 4 or it may be a discrete sheet that is either permanently or releasably attached to foot portion 14. Pouch-flap 11 often has the same width as top panel 4 and a length that extends from foot-portion 14 to a central portion of top panel 4. A pleat pocket 15 may be formed in pouch-flap 11 adjacent to foot-portion 14 so as to provide space to accomadate the upright feet of a patient 5. Pouch-flap 11 includes a pair of spaced-apart longitudinal peripheral edges 17 and 19 that have fastening means attached to them, such as a conventional zipper mechanism 21, snaps, Velcro®, or the like.

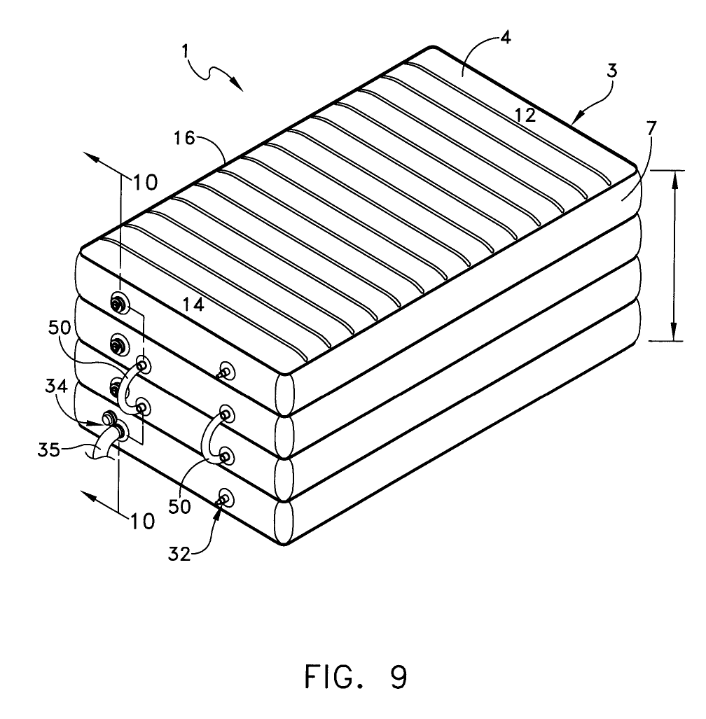

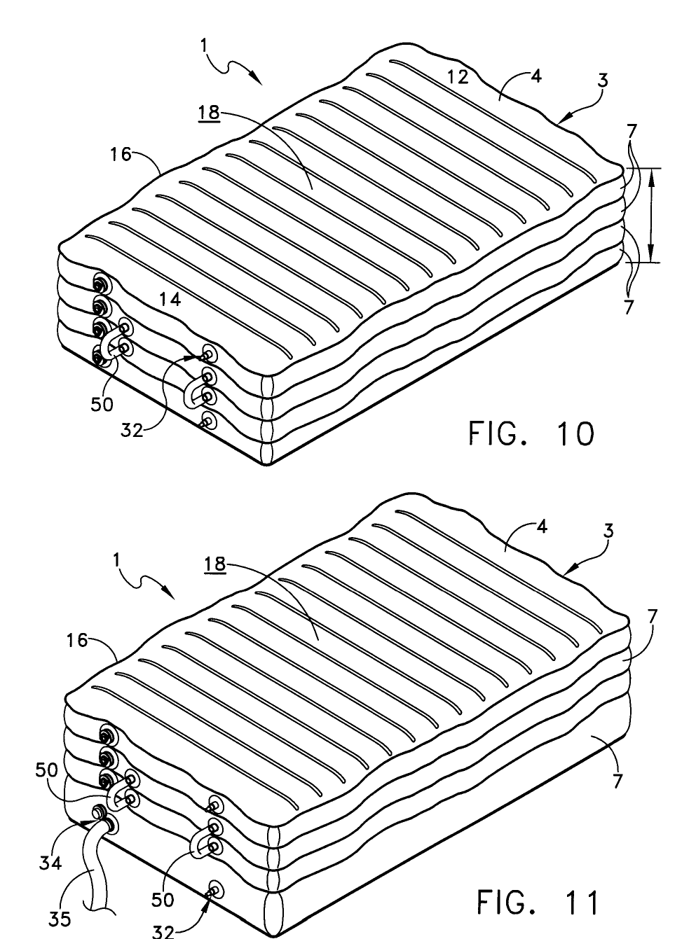

Bottom panel 6 comprises a head portion 22, a foot portion 24, and a peripheral edge 26, and is also formed from a sheet of nylon scrim or the like, that may also be coated on at least its outer surface with a water proof coating. Inner surface 29 of bottom panel 6 may also be coated with a water proof coating as well. Perimeter band 7 extends between peripheral edges 16 and 26, and circumferentially around top panel 4 and bottom panel 6, so as to enclose a central chamber 27 and thereby form each jacking-mattress 3, 3a. Through-bores 30 are defined in the portions of perimeter band 7 that lie between head portions 12, 22 and foot portions 14, 24. Peripheral edges 16 and 26 may have fastening means attached them, such as a conventional zipper mechanism 31, snaps, or the like. A plurality of inlet/outlet fixtures 32 are positioned within through-bores 30 in the central portion of perimeter band 7 (FIG. 8). Each inlet/outlet fixture 32 is sealingly positioned therethrough so as to controllably communicate with central chamber 27 of jacking-mattress 3, 3a. One or more of inlet/outlet fixtures 32 may be a closable opening or a valve 34 that sealingly accepts an air supply hose 35 (FIG. 9) from a source of flowing air of the type well known in the art.

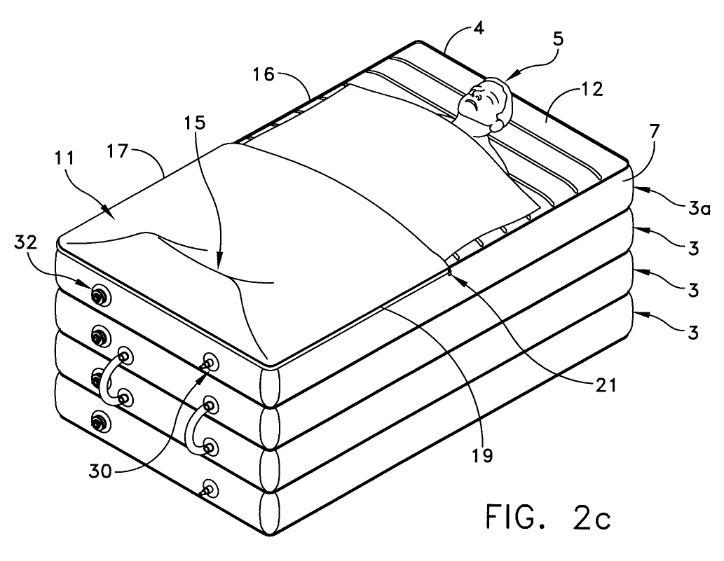

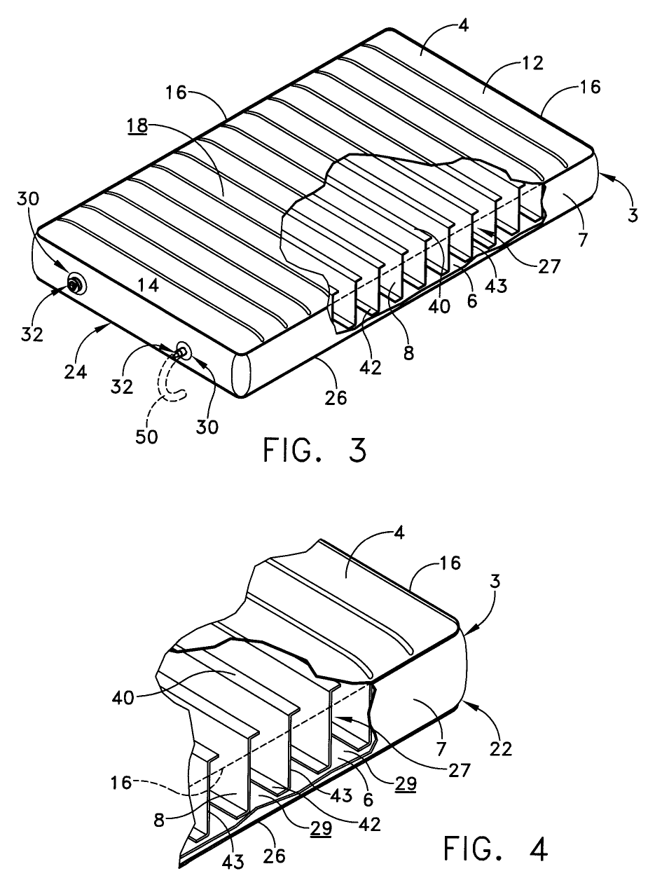

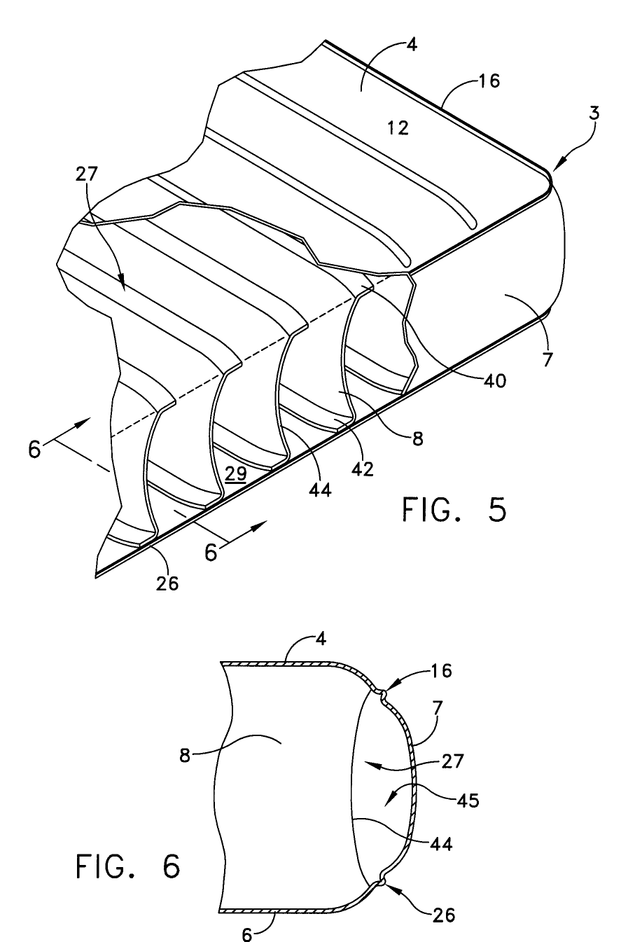

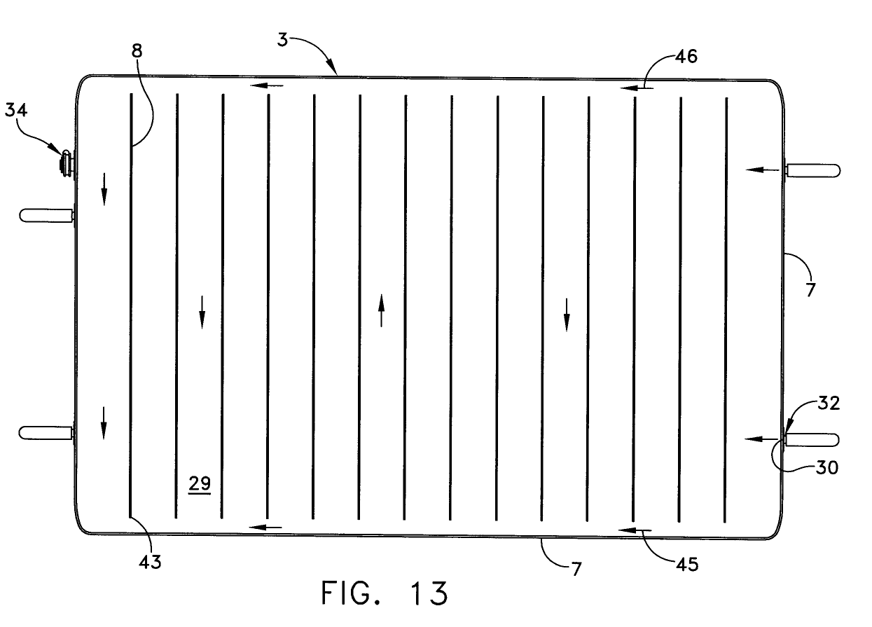

Referring to FIGS. 3-6, plurality of baffle-panels 8 each comprise substantially rectangular sheets of nylon scrim or the like, and include a top edge 40, a bottom edge 42, and end edges 44. Baffle-panels 8 may have differing widths depending upon their position within jacking-mattress 3, 3a. Each top edge 40 is fastened transversely to a portion of the inner surface of top panel 4, and each bottom edge 42 is fastened transversely to a portion of inner surface 29 of bottom panel 6. End edges 44 are arranged in spaced relation to the inner facing surface of longitudinally extending portions of perimeter band 7 (FIGS. 3-6), so as to define a pair of longitudinally oriented air flow channels 45 and 46 (FIG. 13) within each jacking-mattress 3, 3a. In one embodiment, a curved or scalloped end edge 44 (FIGS. 5 and 6) may be employed to increase the size of air flow channels 45 and 46.

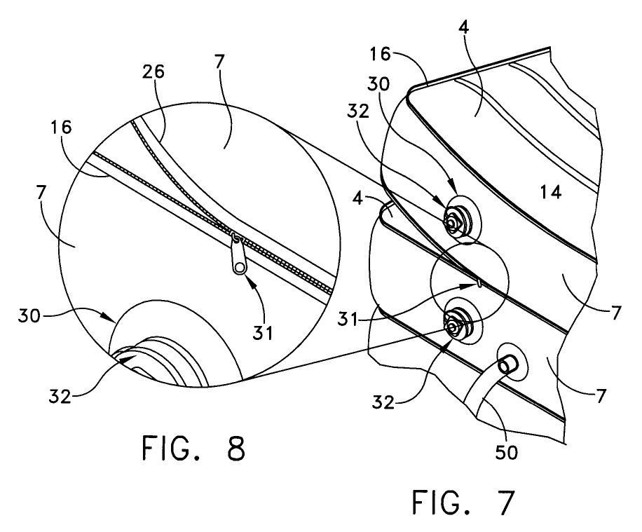

A pneumatic lift 1 is assembled according to the present invention in the following manner. Two, three, four, or more jacking-mattresses 3 are each individually assembled by laying out a bottom panel 6 on a suitable support surface so that baffle-panels 8 may be transversely arranged along the length of inner surface 29. Once in this position, bottom edge 42 of each baffle-panel 8 is fixedly fastened to inner surface 29 of bottom panel 6. Each baffle-panel 8 is often heat sealed along the interface between bottom edge 42 and inner surface 29 of bottom panel 6. This heat sealing may be done with the application of heat or ultrasonic energy at the interface between bottom edge 42 and inner surface 29. Once a plurality of baffle-panels 8 are fastened to inner surface 29 of bottom panel 6, top panel 4 is arranged in overlying confronting relation to bottom panel 6 so that head portion 12 of top panel 4 is confronting head portion 22 of bottom panel 6 and foot portion 14 of top panel 4 is confronting foot portion 24 of bottom panel 6. Once in this position, each top edge 40 of each baffle-panel 8 is fixedly fastened to the inner surface of top panel 4. In order to complete construction of each jacking-mattress 3, it is necessary to sealingly fasten peripheral edge peripheral edge 26 of bottom panel 6 to corresponding edges of perimeter band 7. In one embodiment, conventional zipper mechanisms 31 are fastened to peripheral edges 16 and 26 so that several jacking-mattresses 3 may be stacked, one upon another, and releaseably secured to one another by zippers 31 (FIGS. 7 and 8). Alternatively, jacking-mattresses 3 may be held in a stack by heat sealing their respective peripheral edges 16,26 or by other fastening techniques. In one embodiment, a plurality of air conduits 50 are assembled to the plurality of jacking-matresses 3 so as to interconnect through-bores 30 of adjacent jacking-mattresses 3 in air flow communication, via inlet/outlet fixtures 32.

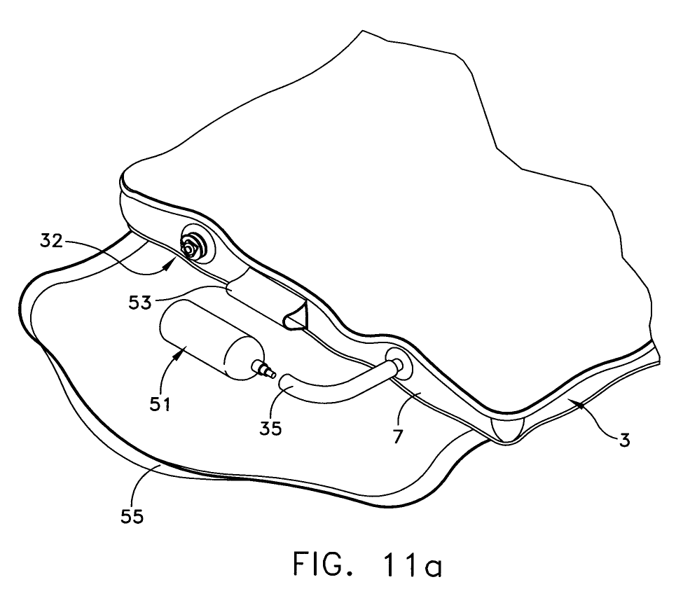

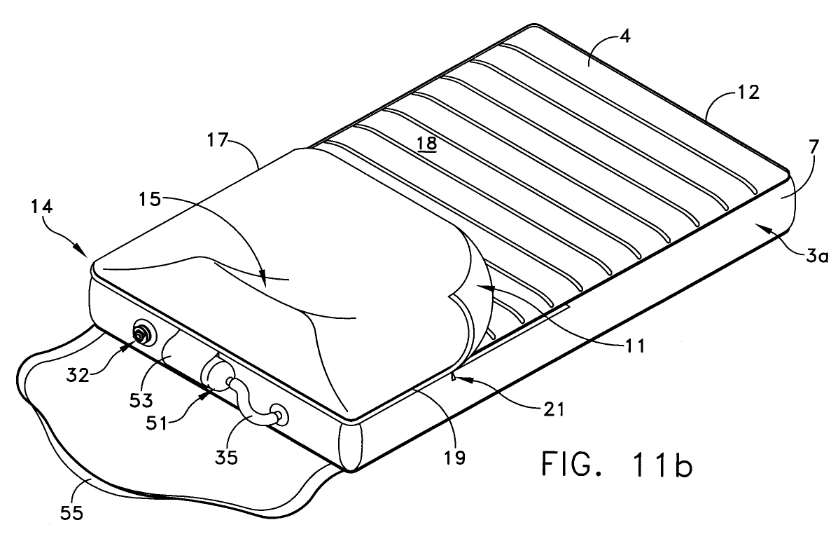

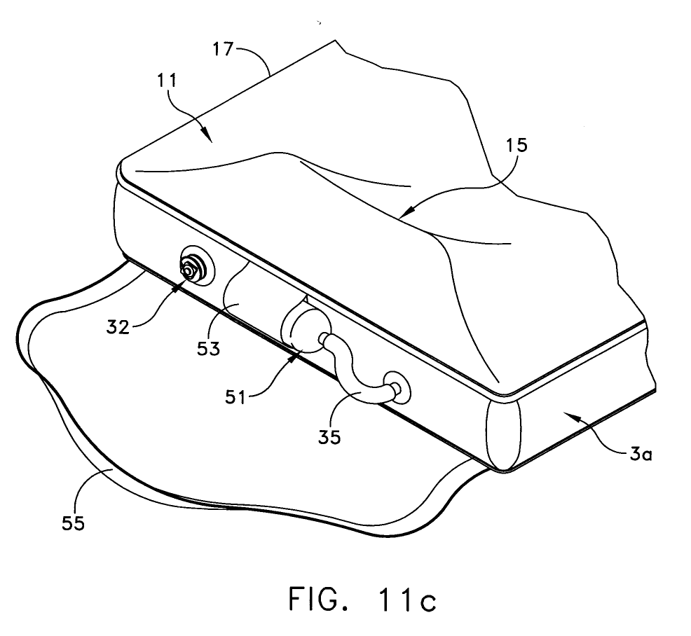

Pneumatic lift 1 is operated in the following manner. An object to be lifted, e.g., a human being 5, is placed atop outer surface 18 of top most jacking-mattress 3 3a, while pneumatic lift 1 is in a fully or partially deflated state (FIG. 10). It will be understood by fully deflated that little or no air will be present in central chambers 27 of each of the stacked jacking-mattresses 3, 3a making up the pneumatic lift. Once the object is in position, high pressure air (e.g., at or around 2.8 psi or between 75 and 100 cubic feet per minute of air flow) is introduced through air supply hose 35 (FIG. 9) which is interconnected in air flow communication with valve 34. In some embodiments of the invention that are suitable for patient evacuation, high pressure air is provided from a gas cylinder 51 located in a pocket 53 that is formed on the outer surface of a lowest most perimeter band 7 (FIGS. 11a. 11b, and 11c).

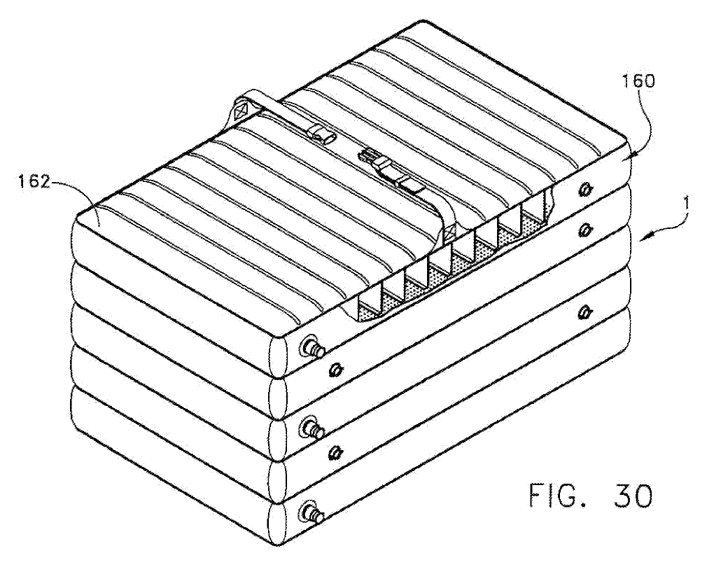

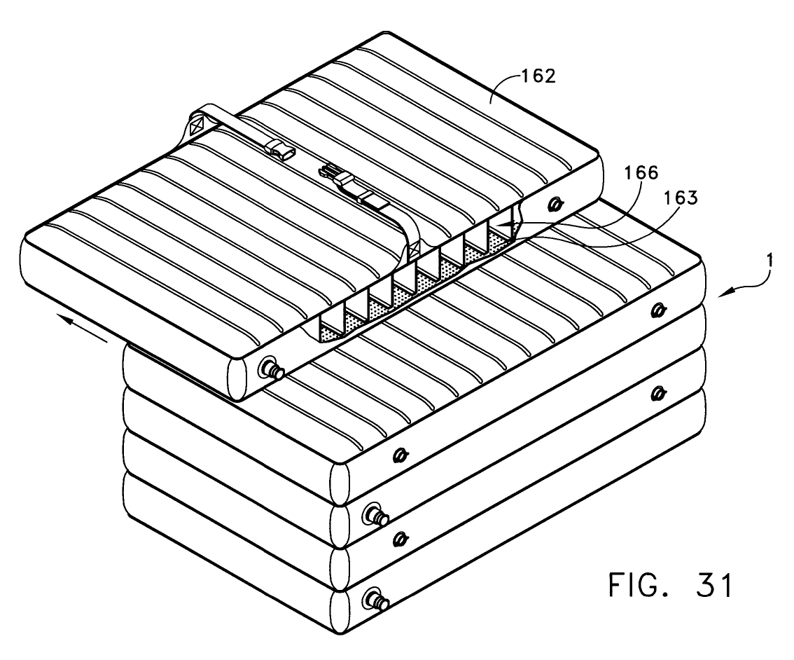

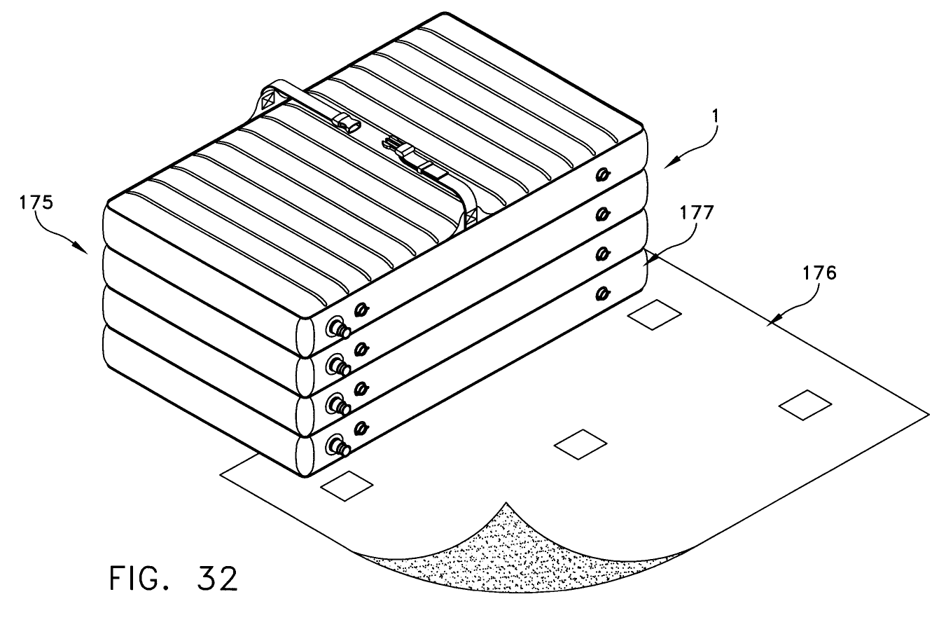

Of course, for evacuation purposes jacking-mattress 3a may be used alone and without being supported upon other jacking-mattresses 3, an will include a bottom sheet 163 (as shown in FIGS. 30 and 31) that is perforated with pinholes 168 over at least a central surface area, and which open up directly to the interior of plenum chamber 166. When jacking-mattress 3a is continuously charged with pressurized air from gas cylinder 51, the escape of air under pressure through pinholes 168 acts initially to lift a patient 5, resting on the outer surface of top sheet 18, above perforated bottom sheet 163 so as to create an air bearing of relatively small height between the outer surface of top sheet 162 and the bottom sheet 163. A pull strap 55 is attached to foot-portion 14 of jacking-mattress 3a so that it may be dragged down a hallway or down several flights of stairs, all while being inflated by gas cylinder 51 ( FIGS. 11a, 11b, and 11c).

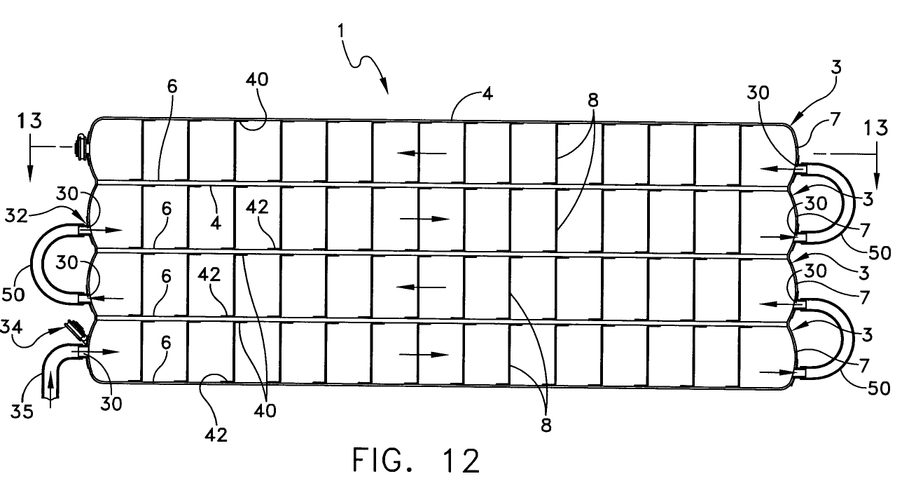

Although not a requirement of the invention, air supply hose 35 is often engaged with valve 34 in the lower most jacking-mattress 3 in the stack forming pneumatic lift 1. As air enters central chamber 27 of the first jacking-mattress 3, it flows through air flow channels 45, and thereby between each of baffle-panels 8 so as to inflate this first jacking-mattress. In one embodiment, air also travels outwardly through-bores 30 and conduits 50 into the next jacking-mattress 3 in the stack, while in another embodiment each individual jacking mattress 3 is separately and often sequentially filled with pressurized air via that jacking-mattress′ own valve 34 (FIGS. 1-13). This air filling process continues until each of jacking-mattresses 3 are completely filled with pressurized air (FIGS. 1, 2, 9, 12, and 14). It will be understood that a maximum achievable height of the fully inflated pneumatic lift 1 will be determined by the number of jacking-mattresses 3 that have been stacked one atop the other. In order to lower an object, it is simply necessary to open one or more inlet/outlets 32 so as to allow the pressurized air to flow outwardly thereby deflating pneumatic lift 1.

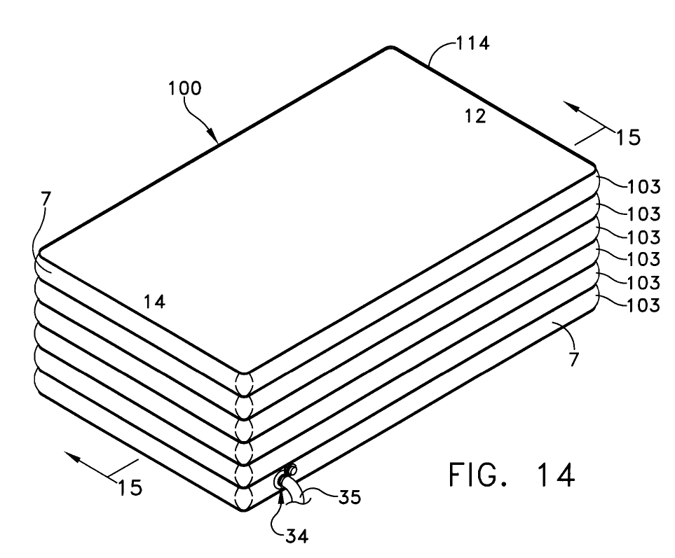

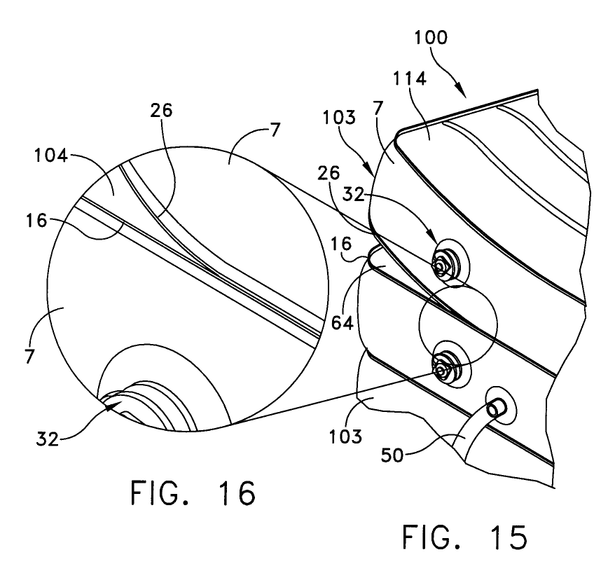

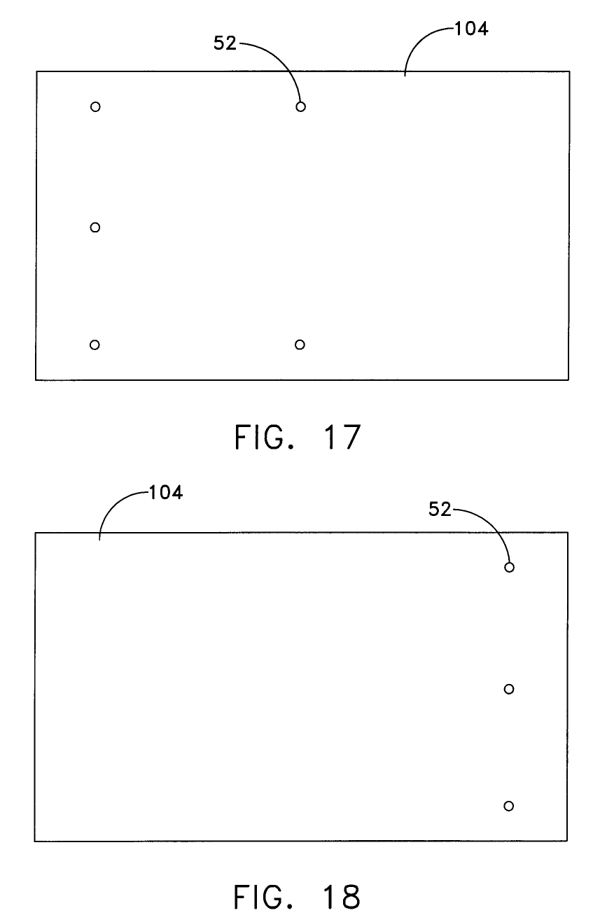

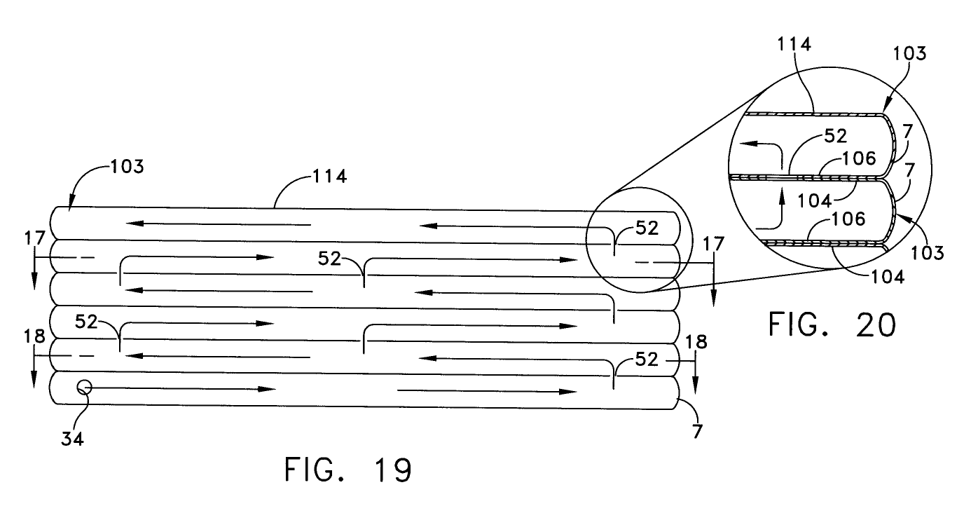

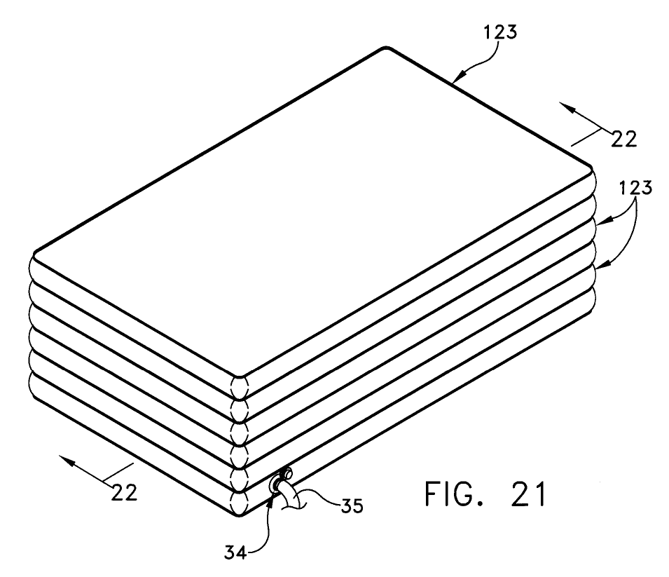

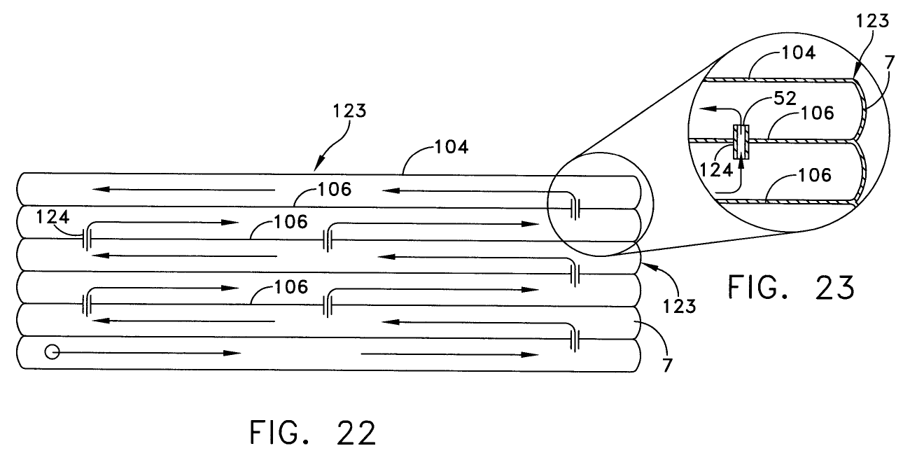

Referring to FIGS. 14-23, it is also possible to form a pneumatic lift 100 in which each jacking-mattress 103 is fixedly fastened to it's adjacent jacking-mattresses. In this embodiment, peripheral edges 16 and 26 are heat sealed or otherwise bonded to one another so as to form an air tight interface extending around the perimeter of adjacent jacking-mattresses (FIGS. 15 and 16). In order to allow for air flow communication between the fixedly fastened jacking-mattresses 103, internally positioned top panels 104 and bottom panels 106 may comprise through-holes 52 (FIGS. 17 and 18) that are arranged so as to allow for free air flow between respective central chambers 27 of adjacent jacking-mattresses 103. Of course, the top most panel 114 and bottom most panel 116 do not include openings so as to maintain air tight inflation.

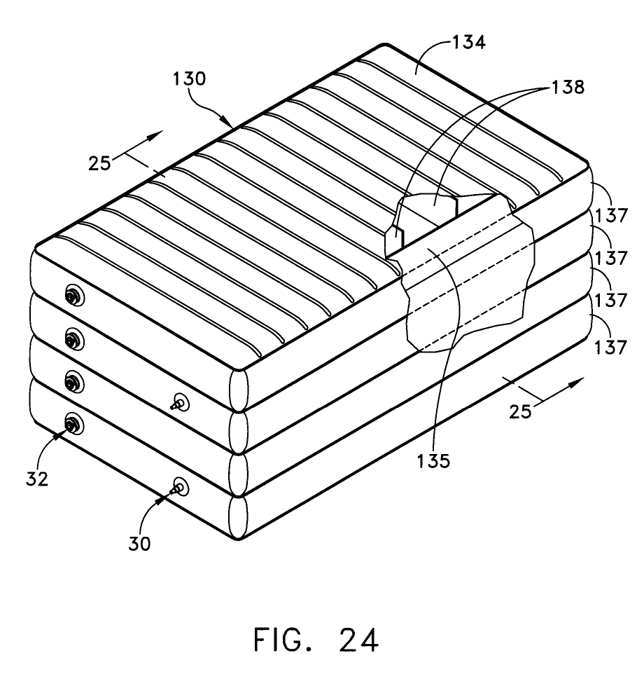

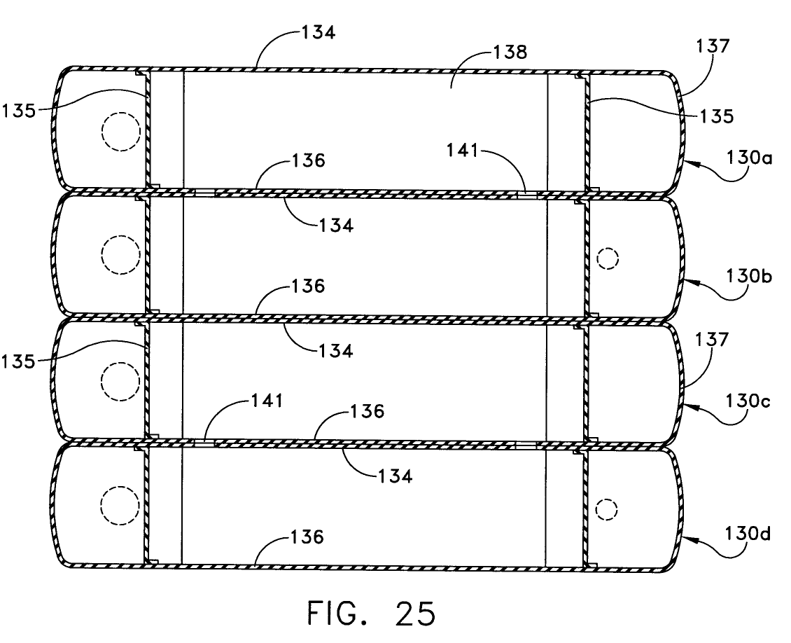

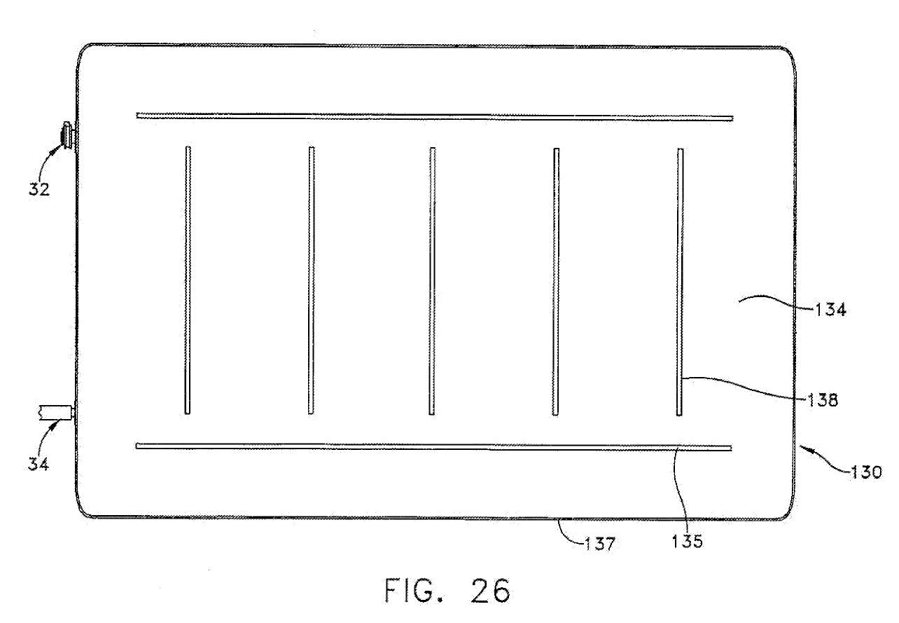

For example, internally situated jacking-mattresses 123 may have common walls forming top panel 104 and bottom panel 106 such that only one through-hole is formed between select panels in order to provide for airflow communication between the select central chambers 27. Fittings 124 may be disposed within openings 52 so as to maintain a fully open configuration during inflation. Referring to FIGS. 24-26, one alternative jacking-mattress 130 includes a top panel 134, a bottom panel 136, a perimeter band 137, a pair of longitudinal baffles 135, and a plurality of internally disposed, transverse baffle-panels 138. Adjacent, intermediate top and bottom panels 134,136 also comprise through-holes 141 that communicate between selected ones of the jacking-mattresses so that they are arranged in internal air flow communication with one another. In one embodiment, selected pairs of jacking-mattresses are arranged in internal fluid flow communication, e.g., between 130a and 130b and between 130c and 130d, but not between 130a and 130d or 130b and 130c. This arrangement allows for a more controlled inflation and deflation of the jacking-mattress.

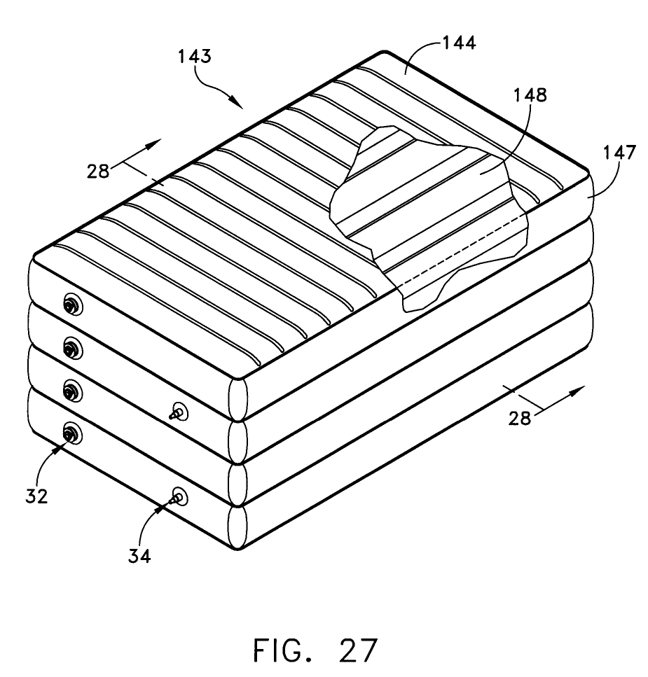

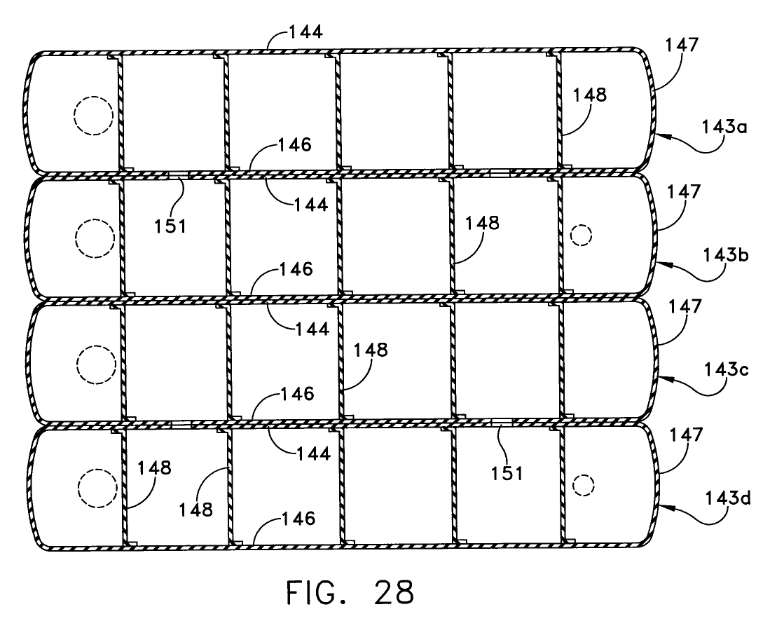

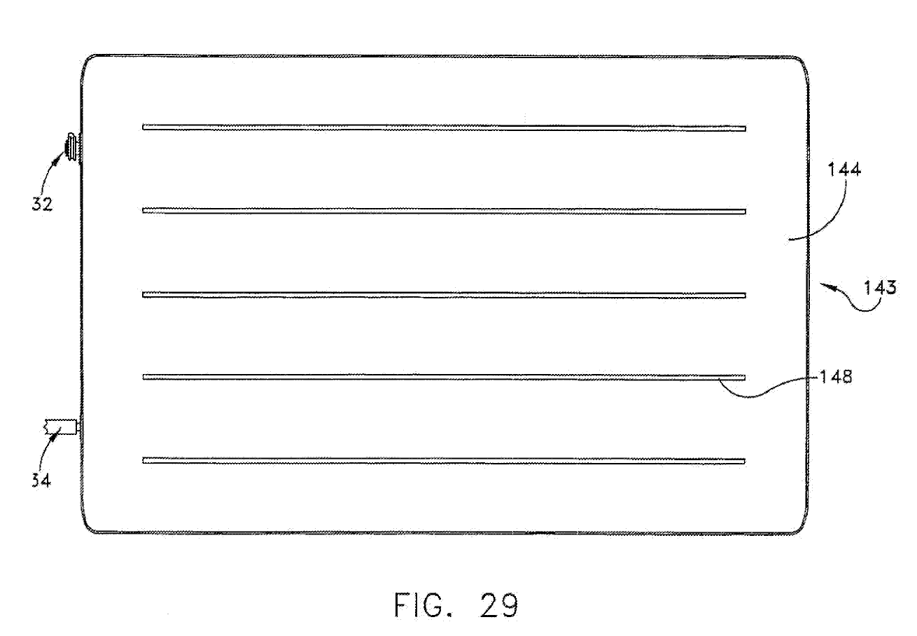

Additionally, another alternative jacking-mattress 143 includes a top panel 144, a bottom panel 146, a perimeter band 147, and a plurality of internally disposed, longitudinal baffle-panels 148 (FIGS. 27-29). Adjacent, intermediate top and bottom panels 144,146 also comprise through-holes 151 that communicate between selected ones of the jacking-mattresses so that they are arranged in internal air flow communication with one another. In one embodiment, selected pairs of jacking-mattresses are arranged in internal fluid flow communication, e.g., between 143a and 143b and between 143c and 143d, but not between 143a and 143d or 143b and 143c. However, in this embodiment, baffles 148 are arranged longitudinally in spaced transverse relation to one another. This arrangement allows for a more controlled inflation and deflation of the jack while at the same time providing greater stability when unloading the jack.

Referring to FIGS. 30-31, it is often the case that a patient will need to be transferred to and from a jacking-mattress when it is in a fully inflated state. In these cases it is convenient to utilize a transfer mattress 160 such as the one disclosed in U.S. Pat. No. 6,073,291, issued to Davis, and incorporated herein by reference. Transfer mattress 160 may be positioned atop the jacking-mattress to further facilitate the transfer of patients. More particularly, a transfer mattress 160 suitable for use with the present invention will often include a flexible top sheet 162 and a flexible bottom sheet 163, that together define a plenum chamber 166. Bottom sheet 163 is perforated with pinholes 168 over at least a central surface area, and which open up directly to the interior of plenum chamber 166. When transfer mattress 160 is continuously charged with pressurized air, the escape of air under pressure through pinholes 168 acts initially to lift a patient, resting on the outer surface of top sheet 162, above perforated bottom sheet 163 so as to create an air bearing of relatively small height between the outer surface of top sheet 162 and the bottom sheet 163.

The patient may be transferred from a fully inflated jacking-mattress using transfer mattress 160 by first inflating the jacking-mattress, as described hereinabove, and then inflating transfer mattress 160. Once inflated, and positioned adjacent to another surface, e.g., a bed, a nurse or other health care worker need merely to slide transfer mattress 160 off of the jacking-mattress to position the patient atop the bed. Once atop the bed, transfer mattress 160 may be deflated so as to position the patient on the bed.

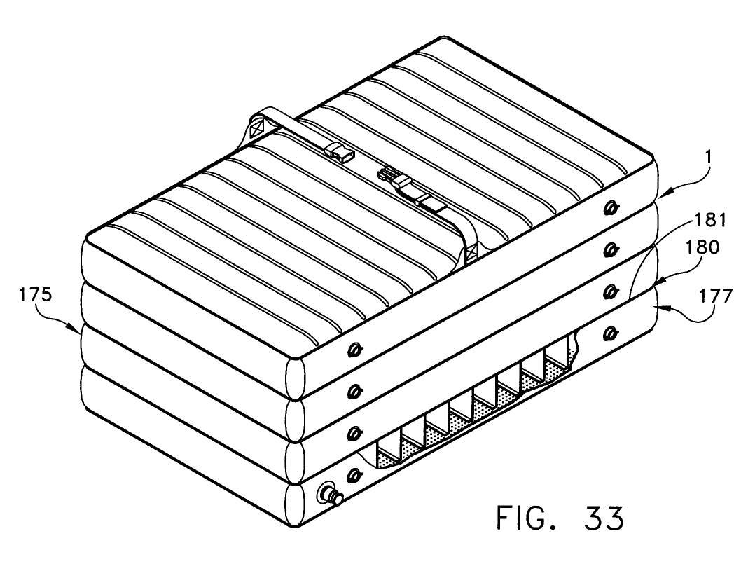

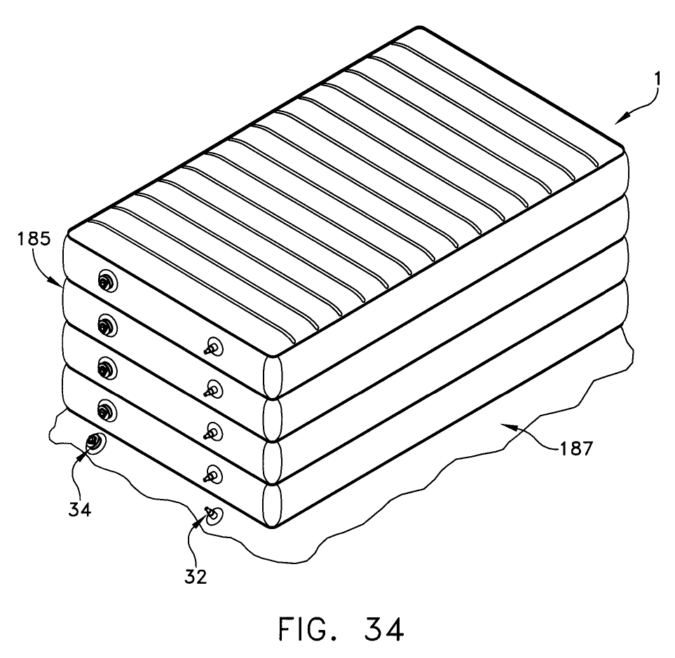

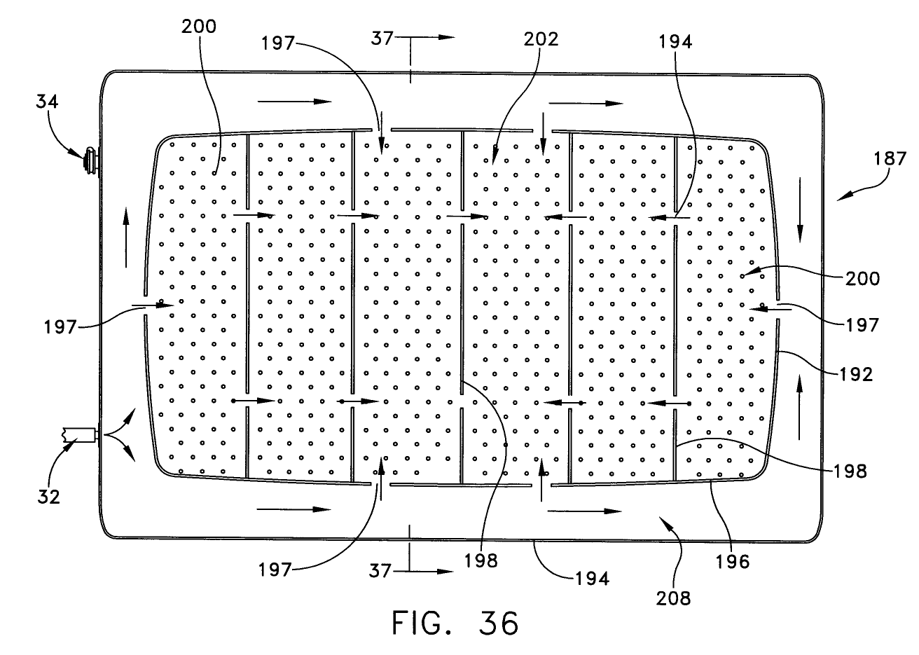

In some cases, it will be necessary to transport the patient while they are lying atop the jacking-mattress. Referring to FIGS. 32-36, a jacking-mattress 175 may be formed in accordance with the present invention having either a sheet of low friction material 176 attached to its lowest most jacking-mattress or a transfer mattress 177 as its lowest most jacking-mattress. Low friction sheet 176 may be formed from polytetraflouroethylene 178, commonly referred to as Teflon®. It may be attached to the bottom surface of jacking-mattress 175 by, e.g., Velcro® hook and felt fasteners 179. Alternatively, transfer mattress 177 may be attached to jacking-mattress 175 by having their respective peripheral edges 180 and 181 fastened to one another by, e.g., a conventional zipper mechanism, snaps, or by heat sealing.

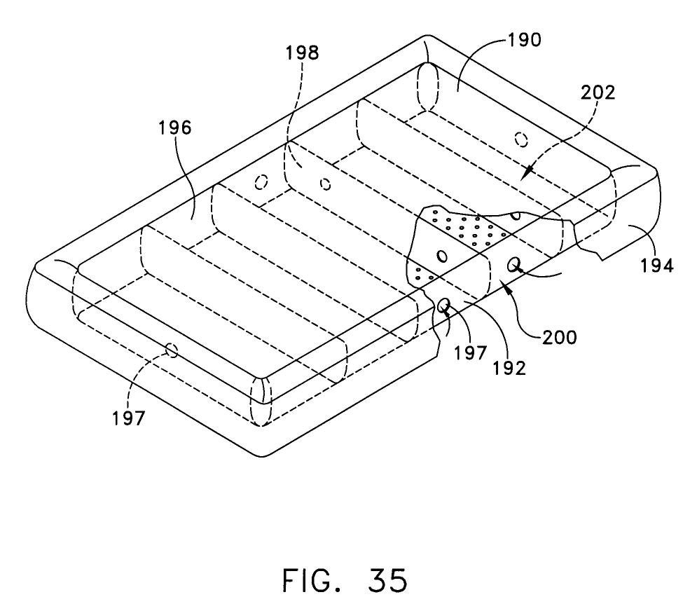

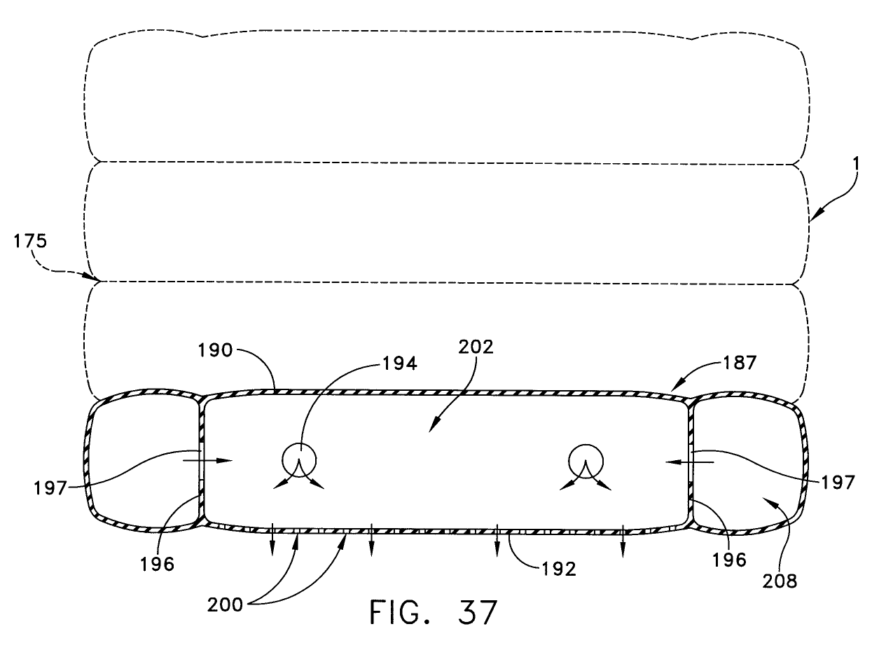

In a preferred embodiment, a jacking-mattress 185 comprises a transfer mattress 187 having a top sheet 190, a bottom sheet 192, an outer perimeter band 194, an inner perimeter band 196, and a plurality of internally disposed, transverse baffle-panels 198 (FIGS. 35-37). Transfer mattress 187 is similar in general construction to transfer mattress 160, in that top sheet 190 is attached at its peripheral edges to bottom sheet 192 via perimeter band 194. Bottom sheet 192 is perforated with pinholes 200. However, in this embodiment, pinholes 200 are present in bottom sheet 192 so as to only communicate with a centrally located individual chambers 202 that are defined by plurality of transverse baffle-panels 198. Chambers 202 are encircled and enclosed within transfer mattress 187 by inner perimeter band 196. Inner perimeter band 196 is periodically perforated with through-holes 197. Baffle panels 198 may also include through holes 199 (FIG. 37). An annular air flow passageway or plenum chamber 208 is defined within transfer mattress 187 that encircles and encloses central chamber 202 defined by inner perimeter band 196 and plurality of transverse baffle-panels 198 within transfer mattress 187.

When transfer mattress 187 is charged with pressurized air, plenum chamber 208 is filled with air first. Central chamber 202 fills with air via through-holes 197 in inner perimeter band 196. In this way, an annular portion of bottom sheet 192 bulges outwardly so as to form a skirt that surrounds that portion of bottom sheet 192 that comprises pinholes 200. The escape of air under pressure through pinholes 200 acts to lift already inflated jacking-mattress 185, which may then be slid along the ground on a cushion of air created by pinholes 200.

It is to be understood that the present invention is by no means limited only to the particular constructions herein disclosed and shown in the drawings, but also comprises any modifications or equivalents within the scope of the claims.

What is claimed is:

1. A pneumatic lift comprising:
at least three jacking-mattresses stacked one atop another wherein at least two of said jacking-mattresses are arranged in internal air flow communication with one another, and a top one of said jacking mattresses defines a foot end with a pouch-flap secured to said foot end so as to form a pocket.

2. A pneumatic lift according to claim 1 wherein each of said jacking-mattresses comprise a top panel having a peripheral edge and a bottom panel having a peripheral edge with a perimeter band sealed to and extending between said peripheral edges so as to define an internal chamber wherein said pouch-flap is secured to said foot end adjacent to at least one of said peripheral edges.

3. A pneumatic lift according to claim 2 wherein said top panel, said bottom panel, and said pouch-flap are each formed from a sheet of nylon scrim.

4. A pneumatic lift according to claim 2 wherein a portion of said peripheral edges include cooperative means for releasably fastening corresponding periheral edges of said pouch-flap to said top one of said jacking mattresses.

5. A pneumatic lift according to claim 2 wherein said perimeter band defines a fluid flow inlet/outlet fixture that is sealingly positioned therethrough so as to controllably communicate with said internal chamber.

6. A pneumatic lift comprising:
at least four jacking-mattresses stacked one atop another wherein select ones of said jacking-mattresses are arranged in internal air flow communication with another of said jacking-mattresses and a top one of said jacking-mattresses defines a foot end of said pneumatic lift with a pouch-flap secured to said foot end and arranged so as to form a pocket; and
a source of pressurized air arranged in airflow communication with said select ones of said jacking-mattresses thereby to sequentially inflate all of said jacking-mattresses when an object is placed upon a top most one of said jacking-mattresses wherein a portion of said object is located within a pocket formed by said pouch-flap.

7. A pneumatic lift according to claim 6 wherein each of said jacking-mattresses is fixedly fastened to an adjacent jacking-mattress and portions of said pouch-flap are releasably fastened to said top most of said jacking-mattresses.

8. A pneumatic lift according to claim 7 wherein each of said jacking-mattresses comprises a top peripheral edge and a bottom peripheral edge that are bonded to one another so as to form an air tight interface extending around the top and bottom perimeter of said adjacent jacking-mattresses and further wherein said pouch-flap comprises an edge that is secured to at least one of said top peripheral edge and said bottom peripheral edge at said foot end.

9. A pneumatic lift according to claim 6 wherein each of said jacking mattresses include a top panel and a bottom panel with at least one through-hole being defined between internally positioned top panels and bottom panels, said through-holes being arranged so as to allow for free air flow communication between adjacent jacking-mattresses.

10. A pneumatic lift according to claim 6 each of said jacking-mattresses is fixedly fastened to an adjacent jacking-mattress.

11. A pneumatic lift according to claim 6 wherein each of said jacking-mattresses comprise a top peripheral edge and a bottom peripheral edge that are bonded to one another so as to form an air tight interface extending around the top and bottom perimeter of said adjacent jacking-mattresses and further wherein said pouch-flap comprises an edge that is secured to at least one of said top peripheral edge and said bottom peripheral edge at said foot end.

12. A pneumatic lift comprising:
a plurality of jacking-mattresses stacked one atop another wherein select ones of said jacking-mattresses are arranged in internal air flow communication with one another, each of said jacking-mattresses comprising;
a top panel having a width, a length, a peripheral edge;
a bottom panel having said width, said length, and a peripheral edge;
a perimeter band extending between said top panel and said bottom panel such that said peripheral edges of said top and bottom panels are sealingly fastened to one another, said peripheral band defining at least one through-hole;
a pouch-flap secured to a portion of said peripheral edge adjacent to a foot end of said pneumatic lift and arranged so as to form a pocket;
a plurality of baffle-panels each having a width and a length and being attached to an inner surface of said top panel and an inner surface of said bottom panel so as to define air flow passageways;
at least one conduit arranged in air flow communication between said at least one through-hole in adjacent jacking-mattresses; and
a source of pressurized air arranged in airflow communication with one of said at least one through-holes so as to be in airflow communication with the interior of one of said jacking-mattresses.

13. A transportable pneumatic lift comprising:
at least three jacking-mattresses stacked one atop another wherein at least two of said jacking-mattresses are arranged in internal air flow communication with one another wherein a top one of said jacking mattresses defines a foot end with a pouch-flap secured to said foot end so as to form a pocket; and
a sheet of Teflon releasably fastened to a bottom surface of a bottom most one of said at least three jacking mattresses.

14. A transportable pneumatic lift according to claim 13 wherein said sheet of Teflon is coextensive with said bottom most one of said at least three jacking mattresses.

15. A transportable pneumatic lift comprising:
at least three jacking-mattresses stacked one atop another wherein at least two of said jacking-mattresses are arranged in internal air flow communication with one another wherein a top one of said jacking mattresses defines a foot end with a pouch-flap secured to said foot end so as to form a pocket; and
a transfer mattress fastened to a bottom most one of said at least three jacking mattresses.

16. A transportable pneumatic lift according to claim 15 wherein said transfer mattress comprises a top sheet and a bottom sheet, that together define a plenum chamber with said bottom sheet being perforated with pinholes over at least a central surface area, said pinholes being in open flow communication with said plenum chamber so that when said transfer mattress is continuously charged with pressurized air from a gas cylinder, said air escapes through said pinholes so as to create an air bearing of relatively small height below an outer surface of said bottom sheet.

17. A pneumatic lift comprising:
a plurality of jacking-mattresses stacked one atop another, each of said jacking-mattresses comprising;
a top panel having a width, a length, a peripheral edge and a foot end and including a pouch-flap secured to a portion of said peripheral edge adjacent to said foot end and arranged so as to form a pocket;
a bottom panel having said width, said length, and a peripheral edge;
a perimeter band extending between said top panel and said bottom panel such that said peripheral edges of said top and bottom panels are sealingly fastened to one another, said peripheral band defining at least one through-hole;
a plurality of baffle-panels each having a width and a length and being attached to an inner surface of said top panel and an inner surface of said bottom panel so as to define air flow passageways;
at least one valve sealingly positioned within said at least one through-hole so as to provide air flow access to said air flow passageways; and
a source of pressurized air having a conduit suitable to be sequentially received in airflow communication with each of said at least one valves so as to be in sequential airflow communication with the interior of each of said jacking-mattresses.

18. A pneumatic lift according to claim 17 comprising a plurality of longitudinal baffle panels.

19. A pneumatic lift according to claim 17 comprising a plurality of transverse baffle panels.
